(19) United States
(12) Patent Application Publication
(10) Pub. No.: US 2006/0032199 A1
(43) Pub. Date: Feb. 16, 2006

(54) Portable air purifier

(76) Inventors: R. Paul Beam, Knoxville, TN (US); James Normark, Mt. Carmel, TN (US); David Sutton, Greeneville, TN (US); Tom Greene, Morristown, TN (US); Neal Morris, Greeneville, TN (US)

Correspondence Address: BAKER, DONELSON, BEARMAN,;CALDWELL & BERKOWITZ, P.C., 5 CONCOURSE PARKWAY, STE. #900, ATLANTA, GA, 30328, US

(21) Appl. No.: 10/918,322

(22) Filed: Aug. 13, 2004

(51) Int. Cl. B01D 46/00

(52) U.S. Cl. 55/471

(57) ABSTRACT

A portable air purifier for purifying air in selected occupied spaces, comprising a base for attaching to a support in the space, a housing pivotally mounted to the base, a fan mounted within the housing and having an air inlet and an air outlet for communicating air through the housing and at least one air treatment device supported in the housing for acting upon air communicated by the fan.

### TECHNICAL FIELD

The present invention relates to air purifiers. More particularly, the present invention relates to portable air purifiers for purifying air in selected spaces.

### BACKGROUND OF THE INVENTION

In recent years, attention has increasingly been directed to the quality of air breathed by persons in homes, offices, restaurants, hotels, and the like. This attention derives from the perception that airborne dust, allergens, and microorganisms such as germs and bacteria, affect the health of persons breathing the air. Often HVAC systems seek to exchange exterior air as fresh with air contained within an interior space. Notwithstanding the mix of a proportion of exterior air with interior air, increases in odors, dust and airborne particulates, and microorganisms, can become quite concentrated in interior spaces. Even the introduction of exterior air however does not necessarily reduce such airborne materials as exterior air often includes pollen, dust, dirt, and airborne pollutants.

A variety of devices have been provided for treatment of air in interior spaces. These include filtration devices such as particulates filters that remove larger particles from the air, electrostatic filters that trap particles sensitive to electrostatic charges and odor filters that remove odors or scent the air. Odor filters include activated carbon or charcoal that remove pollutants primarily by absorption as well as fragrancing media to provide a pleasant odor. Some air purifier devices that include filtration mechanisms also include additional air purification features. These include UV quartz lights for destroying germs and pathogens carried in the air as well as generate ozone. Other devices generate positive or negative ions. The ions emitted into the air tend to electrostatically cling to pollutants having opposing charges. The attached ions increase the weight of the air-born particles and cause the particles to fall to the ground, thereby clearing the air of dust and other pollutants.

While various devices have been provided for interior spaces of homes and office buildings, there are other semi-enclosed environments occupied by persons which raise concerns as to the quality of the air in the environment. For example, motor vehicles generally have small enclosed cabs for occupancy by a driver and passengers. Many motor vehicles today have selective settings for operation of the HVAC system. A first setting enables the driver to primarily recirculate air within the compartment. This facilitates a more rapid change in temperature by continued heating or cooling of the air within the compartment. A second operating mode communicates exterior air into the cab for mixing with interior air. In many motor vehicles available today, the exterior air passes through a particulate filter to remove larger particles from the exterior air communicated into the cab. Notwithstanding the recirculation mode of operation, there is generally always some exterior air communicated into the interior of the cab, with concurrent outflow of air from the interior of the cab. While such particulate filtering of exterior air reduces the larger particulates in the cab, this does not readily purify the air within the cab. For long trips or for persons traveling with someone who is smoking, the air can become uncomfortable for breathing.

Further, the spaces using these devices for purifying air are generally occupied by persons lacking operational control or authority over the purification device. A purification device that is not working properly, that requires routine but unprovided maintenance, or is not effective as to particular contaminants, particulates, bio-organisms, or other air-borne material, may be at best counter-productive by creating merely an appearance of purification activity.

Accordingly, a need remains in the art for a portable air purifier selectively operational by an occupant of a space for purifying air. It is to the provision of such that the present invention is directed.

### SUMMARY OF THE INVENTION

The present invention meets the need in the art by providing a portable air purifier useful for purifying air in closed spaces. The air purifier comprises a housing that connects by a base to a support surface of a closed space. The housing includes a fan having an air inlet and an air outlet for communicating air through the housing. The housing includes purification devices for treating air communicated by the fan through the housing.

Objects, features, and advantages of the present invention will become apparent upon a reading of the following detailed description in conjunction with the drawings and the appended claims.

### BRIEF DESCRIPTION OF THE DRAWINGS

FIG. 1 is a perspective partial view of an interior of a motor vehicle having an air purifier according to the present invention mounted to a dashboard of the motor vehicle.

FIG. 2 is an exploded perspective view of the air purification device illustrated in FIG. 1.

### DETAILED DESCRIPTION

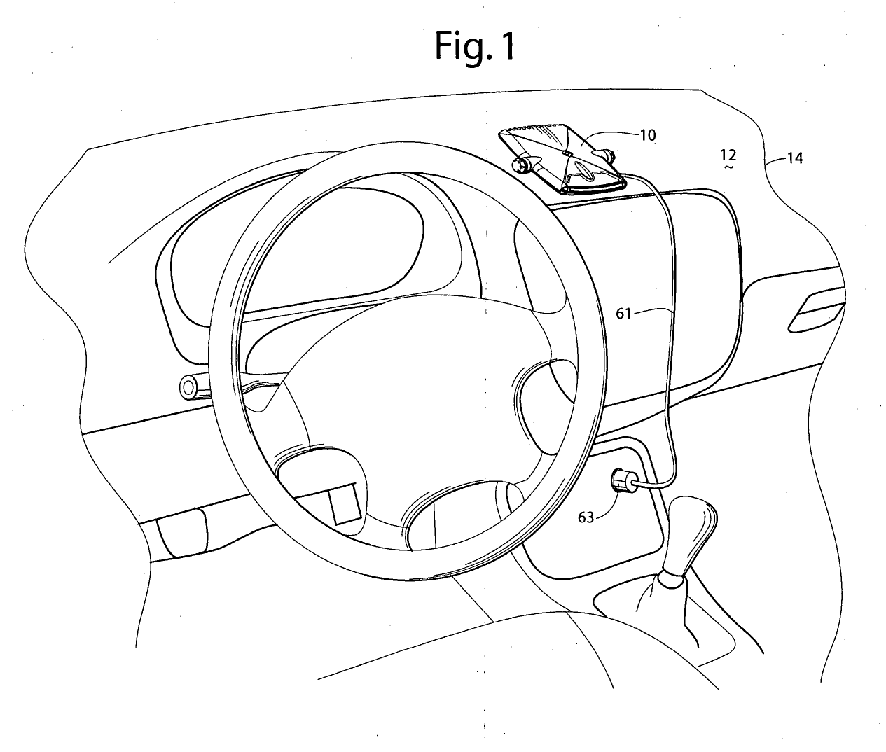

With reference to the drawings, in which like parts have like identifiers, FIG. 1 illustrates in perspective detailed view an air purifier 10 useful selectively in closed spaces for purifying air (such as the illustrated mounting of air purifier to a dashboard 12 of a motor vehicle 14 for treating air within the interior generally 16 of the motor vehicle).

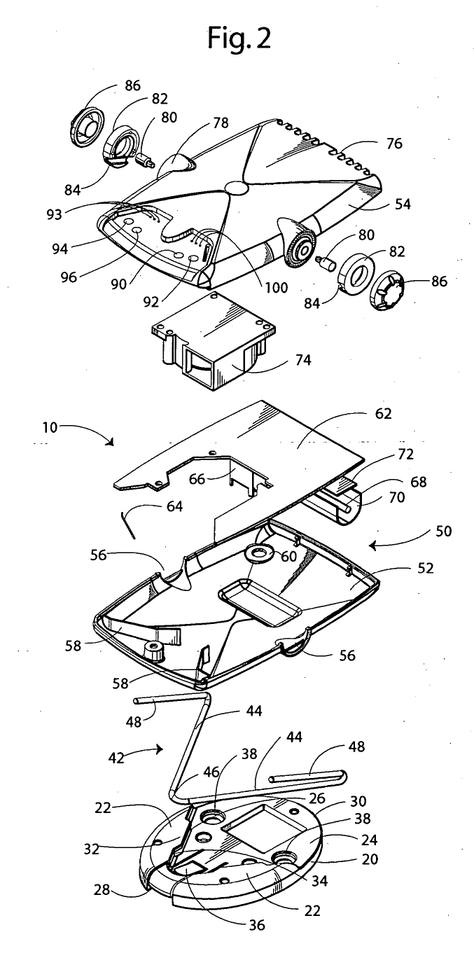

FIG. 2 illustrates in exploded perspective view the air purifier 10 according to the present invention. The air purifier 10 includes a base 20 having a pair of raised portions 22 relative to a recessed or valley portion 24. The raised portions each include a face 26 disposed at an oblique angle relative to a longitudinal axis extending between an outlet side 28 and an inlet side 30 of the base 20. A lip 32 extends laterally from the raised portion 22 outwardly from the face 26 over the valley portion 24. The lip 32 cooperates with the face 26 to define a slotted recess 34. A flexible tongue 36 extends from the valley portion to have a free distal end towards the outlet side 28. The valley portion 24 further defines a pair of opposing openings 38 for receiving fasteners to selectively attach the base 20 to the dashboard 12 of the motor vehicle 14.

A wire stand generally 42 includes opposing base members 44 extending from an apex 46. The base members 44 are disposed at a relative angle that conforms to the angle of the faces 26 in the raised portions 22. Distal arms 48 extend away from the base 20 at an oblique angle relative to a plane passing through the base members 44 of the wire stand 42. The wire stand 42 attaches to the base 20 by positioning the base members 44 in the opposing slotted recesses 34. The tongue 36 engages the apex 46 to latch the wire stand to the base 20.

The air purifier 10 includes a housing 50 made of a bottom 52 and an opposing top 54. The bottom 52 has a dish-shape that defines a bottom with upstanding sidewalls. Opposing sidewalls define notches 56. An outlet side of the bottom has opposing plates 58. The bottom also defines an opening 60 for power leads. FIG. 1 illustrates a power lead 61 having an adaptor 63 for connecting a circuit board 62 to a power outlet in the motor vehicle.

The circuit board 62 mounts to the top 54. An ionization needle 64 attaches to operating circuitry on the circuit board 62. A lamp socket 66 connects to the circuit board. The lamp socket 66 receives a ultraviolet bulb 68. A photocatalytic screen 70 mounts to the circuit board 62 in over-wrapping spaced-apart relation to the bulb 68. A purification plate 72 attaches to the circuit board 62 in spaced-apart relation to the UV bulb 68. The purification plate 72 includes a non-electrically-conductive substrate or plate with conductive members on opposing sides that communicate with a supply of electrical current.

The purification plate provides a corona discharge device for generating ozone, such as part TF347 available from TT Electronics IRC—Advanced Film Division, Corpus Christi, Tex. That purification plate includes a ceramic substrate with a glass coating on opposing major sides and a electrical conductor material (tungsten-based) printed as patches on the surface of the glass coating on the opposing sides. The electrical conductor material is selected for being resistant to corrosion by ozone. The opposing patches connect to a supply of electrical current. Copper patches are applied to the opposing sides to provide a solderable connection for leads and supports connecting the plate to the circuit board. While the patches may be of consistent size, the patch printed on the side exposed to the airflow in the air purifier 10 is smaller in area that the patch on the opposing side, whereby the corona discharge is forced to the side exposed to the air flow.

The circuit board 62 defines a notched opening that matingly receives a fan housing 74. The fan housing includes a fan operated by a motor for communicating air from an air inlet to an air outlet. The top 54 of the housing 50 defines an air intake grill generally 76 at an intake side of the air purifier 10.

Opposing sides of the top define laterally protruding supports 78. Each support 78 includes a threaded opening that receives a threaded insert 80 extending from a knob 86. An annular ring 82 defines an opening through which the insert extends. An interior face of the ring 82 defines an elongate slot 84 which receives a respective one of the arms 48, as discussed below. The rings 82 allow the housing to pivot towards and away from the dashboard for selectively orienting the outflow air. The knob 86 selectively rotates in a first direction to tighten the ring 82 against an exterior face of the support 78 and rotates in an opposite direction to loosen the ring relative to the support. Tightening the knob causes the ring to bear tightly against the arm 48 in the slot 84. This secures the housing 50 in a selected angled position relative to the base 20.

With reference to FIG. 1, the base 20 mounts to the dashboard 12 with fasteners, such as screws, through the openings in the valley portion 24 of the base. The base 20 can alternatively be detachably attached to the dashboard with adhesive-backed hook and loop fabric connectors, such as VELCRO fastener tape, or can be secured by other fasteners, such as suction cups to smooth surface or glass or with screws or other fasteners.

In the illustrated embodiment, the base members 44 of the wire stand 42 are moved angularly towards each other relative to the apex in order to receive the base members 44 in the opposing slotted recess 34 of the base 20. The free arms 48 attach to the housing 50. This is accomplished by passing the free distal end of the arms 48 into the slots 84 in the rings 82. The housing 50 is positioned with respect to the base to direct the air outflow in a selected direction into the interior of the motor vehicle. The opposing knobs 86 are rotated to tighten the rings 82 against the support and thereby fix the housing 50 in the selected orientation.

The air purifier 10 of the present invention operates selectively by a user within a space occupied by the user, for example, the interior 16 of the motor vehicle 14, to purify the air. The electrical lead 61 attaches to a supply of electrical current, such as an adapter socket or cigarette lighter outlet commonly found in motor vehicles. In an alternate embodiment in which the air purifier 10 is incorporated into an HVAC system of a motor vehicle, the electrical leads for the power supply include connectors for attaching to a wiring harness or other appropriate source of current in the motor vehicle. An alternate embodiment of the air purifier includes a socket that connects to an electrical plug from an A/C electrical current adapter, whereby the air purifier 10 is readily transported by a user from a motor vehicle to a selected use location, such as a hotel room, closet, laundry room, office, kitchen, or other space having need for purification of air.

The air purifier 10 includes a switching device for controlling the airflow through for the air purifier. The switching device comprises fan speed up and down control buttons 90, 92 for increasing the fan speed to a maximum or decreasing to zero fan speed, or alternatively, a slide switch for varying the fan speed. In addition, purification level up and down buttons 94, 96 enable selective ozone generation between off or none and a maximum. LED's 98, 100 provide a visual indication of the operational settings.

During operation of the air purifier 10, the fan operates to pull air into the air purifier 10 through the air intake grill 76 and blow treated air out through the outlet. The UV bulb 68 is activated. Current is also supplied to the opposing sides of the purification plate 72.

The air flows through the air intake grill 76 and through the photocatalytic screen 70. This exposes the air to the UV bulb. The UV light destroys pathogens and other biological organisms carried in the airflow. The UV light 68 activates the photocatalytic screen 70. The screen 70 generates hydroxyl radicals. These short-lived radicals react with and neutralize volatile organic compounds in the airflow. The photocatalytic screen 70 may be titanium oxide or other suitable metallic alloy material for generating hydroxyl radicals through exposure to UV light, such as parts RCIC-5A, -9A, -9C, -9HOA, -9HOC, -11HOA, -11C, -14C, -14HOA, -14HOC, -36/5A, -36HOA, and -36UVA available from RGF Environmental Group, Inc. of West Palm Beach, Fla.

The purification plate 72, subjected to high voltage between the opposing printed sides, shorts and sparks to create-ozone which provides for purification of the air. The illustrated embodiment disposes the side of the purification plate having the relatively smaller electrical patch to the air flow. The smaller electrical patch forces the corona discharge to the side in the air flow. Because the air purifier 10 includes the purification plate 72 for generating ozone, the UV lamp 68 can be made of a non-quartz glass. In an alternate embodiment lacking the purification plate 72, the UV lamp 68 can be made of quartz glass to generate ozone.

The ion needle emits a plurality of negative ions into the airflow. The treated air flows through the gap between the two plates 58 and out of the outlet end of the air purifier 10. The negative ions attach to particulates in the air flow and in the space occupied by the user. The heavier particulates fall out of the air. The air is thereby treated to provide air within the passenger compartment (or other selected space) having reduced contaminants.

The present invention accordingly provides an air purifier readily portable for purifying air within close spaces, such as motor vehicles, hotel room, laundry room, and the like. While the invention is described with respect to mounting to a dashboard of a motor vehicle for purifying air, such is not restrictive but merely illustrative of one closed space gainfully benefited by the present invention. Indeed, the principles, preferred embodiments, and modes of operation of the present invention have been described in the foregoing specification. The invention is not to be construed as limited to the particular forms disclosed, as these are regarded as illustrative rather than restrictive. Moreover, variations and changes may be made by those skilled in the art without departing from the spirit of the invention described in the following claims.

What is claimed is:

1. A portable air purifier for purifying air in an occupied space, comprising:
a housing for seating to a support surface of an occupied space;
a fan mounted within the housing and having an air inlet and an air outlet for communicating air through the housing; and
at least one air treatment device supported in the housing for acting upon air communicated by the fan.

2. The air purifier as recited in claim 1, further comprising a pivot mounting for the housing comprising a base; a connector having opposing base-engaging portions and angled arms that connect to the housing; and a pair of members movable from a first position fixed to the housing and a second position for pivotal movement relative to the housing, each member defines a slot that receives a respective one of the angle arms, whereby the housing is selectively positioned relative to the base.

3. The air purifier as recited in claim 2, further comprising a pair of knobs each having a threaded shaft that extends through a respective one of the members and engaging a threaded opening defined in the housing, whereby the knobs rotated in a first direction fix the members to the housing and in a second direction release the member for rotation relative to the housing.

4. The air purifier as recited in claim 1 wherein the air treatment device comprises a light bulb that emits ultraviolet light.

5. The air purifier as recited in claim 4, wherein the light bulb comprises non-quartz glass.

6. The air purifier as recited in claim 1, further comprising an electrical cord communicating electricity from a supply to a control circuit in the housing.

7. The air purifier as recited in claim 1, wherein the air treatment device comprises:
a bulb mounted in the housing for emitting untraviolet light; and
a photocatalytic screen mounted in spaced-relation to the bulb and activated thereby for emitting hydroxel radicals into the air flow in the housing.

8. The air purifier as recited in claim 7, wherein the air treatment device further comprises a corona discharge device for creating ozone.

9. The air purifier as recited in claim 8, wherein the corona discharge device comprises a non-conductive plate having opposing metallic conductors that communicate with a supply of electrical current, whereby the conductors periodically short therebetween by an electrical spark.

10. The air purifier as recited in claim 7, wherein the air treatment device further comprises a needle that emits negative ions into the air flow.

11. A portable air purifier attachable to a support in a closed space for purifying air therein, comprising:
a base for attaching to a support in a closed space;
a housing pivotally mounted to the base;
a fan within the housing having an air inlet and an air outlet for communicating a flow of air through the housing;
a bulb having non-quartz glass for emitting ultraviolet light in the flow of air in the housing;
a photocatalytic screen mounted in spaced relation to the bulb;
a purification plate spaced apart from the photocatalytic screen; and
an ionization needle disposed for emitting negative ions into the airflow communicated from the air outlet of the fan housing.

12. The air purifier as recited in claim 11, wherein the pivot mounting of the housing to the base comprises a flexible member having opposing base-engaging portions and angled arms that connect to the housing; and further comprising a pair of members movable from a first position fixed to the housing and a second position for pivotal movement relative to the housing, each member defines a slot that receives a respective one of the angle arms, whereby the housing is selectively positioned relative to the base.

13. The air purifier as recited in claim 11, further comprising a pair of knobs each having a threaded shaft that extends through a respective one of the members and engaging a threaded opening defined in the housing, whereby the knobs rotated in a first direction fix the members to the housing and in a second direction release the member for rotation relative to the housing.

14. The air purifier as recited in claim 11, further comprising an electrical cord communicating with a control circuit in the housing and having an adapter for engaging a supply of electrical current.

15. A method of purifying air within a motor vehicle, comprising the steps of:
(a) providing a housing within the motor vehicle, which housing defines an air intake and an opposing air outlet;
(b) operating a fan mounted within the housing for communicating air therethrough; and
(c) acting by an air purification device mounted within the air flow of the housing for purifying air passing therethrough.

16. The method of purifying air as recited in claim 15, wherein the step (c) air purification comprises emitting an ultraviolet light from a ultraviolet lamp received in a lamp socket mounted to a support in the housing.

17. The method of purifying air as recited in claim 16, wherein the step (c) air purification further comprises exposing a photocatalytic screen disposed in spaced-apart relation to light from the UV bulb for generating hydroxyl radicals.

18. The method of purifying air as recited in claim 15, wherein the step (c) air purification comprises applying voltage to a purification plate, whereby the purification plate periodically shorts to create a spark and thereby create ozone.

19. The method of purifying air as recited in claim 15, wherein the step (c) comprises generating ions by an ion emitter disposed adjacent the outlet of the fan.

20. The method of purifying air as recited in claim 15, further comprising the step of selectively positioning the housing with opposing annular rings each defining an elongate slot and moveable between a first position bearing an arm of a stand tightly against a side of the housing and a second position with the arm loosely held relative to the housing, whereby the housing can be moved longitudinally relative to the arm for selective positioning of the housing.
